(19) United States
(12) Patent Application Publication
(10) Pub. No.: US 2012/0287113 A1
(43) Pub. Date: Nov. 15, 2012

(54) LIQUID CRYSTAL DISPLAY DEVICE, MOBILE DEVICE, AND METHOD FOR DRIVING LIQUID CRYSTAL DISPLAY DEVICE

(75) Inventors: Masaki Uehata, Osaka-Shi (JP); Kohji Saitoh, Osaka-Shi (JP)

(73) Assignee: SHARP KABUSHIKI KAISHA, Osaka-shi (JP)

(21) Appl. No.: 13/575,485

(22) PCT Filed: Dec. 6, 2010
(86) PCT No.: PCT/JP2010/071835

§ 371 Date: Jul. 26, 2012

(30) Foreign Application Priority Data
Jan. 28, 2010 (JP) 2010-016920

(51) Int. Cl. G09G 3/36; G06F 3/038

(52) U.S. Cl. 345/212; 345/87

(57) ABSTRACT

A liquid crystal display device (1) includes: a pixel circuit (4) in which a retention capacitor is provided; an illuminance sensor (14) for detecting illuminance on a liquid crystal display surface of a liquid crystal panel (2) of the liquid crystal display device; and a CS driver (8) for applying a voltage across the retention capacitor in accordance with the illuminance detected by the illuminance sensor (14).

### REFERENCE TO RELATED APPLICATIONS

This application is a national stage application under USC 371 of International Application No. PCT/JP2010/071835, filed Dec. 6, 2010, which claims priority from Japanese Patent Application No. 2010-016920 filed Jan. 28, 2010, the entire contents of which are incorporated herein by reference.

### FIELD OF THE INVENTION

The present invention relates to a liquid crystal display device for use in an electronic apparatus, a mobile device, and a method for driving the liquid crystal display device.

### BACKGROUND OF THE INVENTION

Liquid crystal display devices are widely used due to their characteristics, such as thinness, lightweight, and low electric current consumption. Recently, uses of such liquid crystal display devices are diversified and they are sometimes used in the outdoors which is affected by the outside light. However, in such an environment where light is strong, such as the outdoors, there is a problem that visibility of a liquid crystal display device is reduced by the influence of the resulting light from reflection of the outside light. In order to solve the problem, a method that suppresses the reduction in visibility has been proposed. In the method, which is carried out by a user, brightness of a display of a liquid crystal display device is adjusted in accordance with an environment where it is used. However, it is troublesome for a user to adjust brightness by hand. In view of the circumstances, widely used are liquid crystal display devices which automatically adjust brightness of displays in accordance with environments where they are used, such as intensity of surrounding light in the environments.

Patent Literature 1 discloses a liquid crystal display device which adjusts brilliance, that is, brightness of a screen. In the liquid crystal display device, a photo-detector detects surrounding brilliance, and backlight intensity is adjusted in accordance with the detected brilliance.

Japanese Patent Application Publication, No. Tokukaihei, 4-174819 A (Publication Date: Jun. 23, 1992)

### SUMMARY OF THE INVENTION

However, a technology described in Patent Literature 1 causes a problem which will be described below. In the technology of Patent Literature 1, backlight intensity is adjusted in accordance with surrounding brilliance, in order to improve display visibility. This allows adjusting brilliance, that is, brightness of the screen. In other words, it is required to increase an electric current to be applied to the backlight in order to increase brightness of the screen. This leads to an increase in electric current consumption.

The present invention has been accomplished in view of the problem, and an object of the present invention is to provide a liquid crystal display device, a mobile device, and a method for driving the liquid crystal display device, which can improve display visibility without increasing electric current consumption, even if surrounding brilliance is changed.

In order to solve the above-mentioned problem, a liquid crystal display device in accordance with the present invention is a liquid crystal display device including: a pixel circuit in which a retention capacitor is provided; illuminance detecting means for detecting an illuminance on a liquid crystal display surface of a liquid crystal panel of the liquid crystal display device; and voltage applying means for applying a voltage across the retention capacitor in accordance with the illuminance detected by the illuminance detecting means.

According to the configuration, the liquid crystal display device of the present invention detects an illuminance on the liquid crystal display surface of the liquid crystal panel. The liquid crystal display device applies then a voltage across the retention capacitor in accordance with the detected illuminance. For example, in a case where a high illuminance is detected, the liquid crystal display device applies an increased voltage across the retention capacitor so as to increase white brightness. In this case, due to the increase in voltage applied across the retention capacitor, black brightness will also be increased. The increase in both white brightness and black brightness results in reduction in contrast. However, in an environment where light is strong, such as the outdoors, the contrast hardly influences visibility. Therefore, in a case where a high illuminance is detected, it is possible to improve display visibility of the liquid crystal panel even in an environment where outside light is strong, such as the outdoors. In contrast, in a case where a low illuminance is detected, display is carried out on a screen with a preset contrast. This generally causes a fine visibility of display. In such a case, the liquid crystal display device does not apply voltage wastefully. Further, it is not required to increase an electric current to be applied to a backlight in order to adjust brightness of the liquid crystal display device. This is because brightness of the liquid crystal display device is adjusted by controlling a voltage to be applied across the retention capacitor. It is thus possible to suppress an electric current consumption. As described above, the liquid crystal display device can thus improve display visibility without increasing electric current consumption, even if surrounding brilliance is changed.

In order to solve the above-mentioned problem, a method for driving a liquid crystal display device in accordance with the present invention is a method for driving a liquid crystal display device, said device including a pixel circuit in which a retention capacitor is provided, said method including the steps of: (i) detecting an illuminance on a liquid crystal display surface of a liquid crystal panel of the liquid crystal display device; and (ii) applying a voltage across the retention capacitor in accordance with the illuminance detected in the step (i).

According to the configuration, the method for driving a liquid crystal display device has the effect same as that of the liquid crystal display device of the present invention.

Other objects, features and advantages of the present invention are to be appreciated with reference to the description below. Further, advantageous effects of the present invention are to be appreciated with reference to the description on the basis of the attached drawings.

As described above, a liquid crystal display device in accordance with the present invention is a liquid crystal display device including: a pixel circuit in which a retention capacitor is provided; illuminance detecting means for detecting an illuminance on a liquid crystal display surface of a liquid crystal panel of the liquid crystal display device; and voltage applying means for applying a voltage across the retention capacitor in accordance with the illuminance detected by the illuminance detecting means. Therefore, the liquid crystal display device can effectively improve display visibility without increasing electric current consumption, even if surrounding brilliance is changed.

Further, a method for driving a liquid crystal display device in accordance with the present invention is a method for driving a liquid crystal display device, said device including a pixel circuit in which a retention capacitor is provided, said method including the steps of: (i) detecting an illuminance on a liquid crystal display surface of a liquid crystal panel of the liquid crystal display device; and (ii) applying a voltage across the retention capacitor in accordance with the illuminance detected in the step (i). Therefore, the method for driving a liquid crystal display device can effectively improve display visibility without increasing electric current consumption, even if surrounding brilliance is changed.

### BRIEF DESCRIPTION OF THE DRAWINGS

FIG. 1 is a block diagram illustrating a configuration of a liquid crystal display device in accordance with an embodiment of the present invention.

FIG. 2 is a diagram illustrating a configuration of a pixel circuit of the liquid crystal display device in accordance with the embodiment of the present invention.

FIG. 3 illustrates how to drive the pixel circuit of the liquid crystal display device in accordance with the embodiment of the present invention.

FIG. 4 is a block diagram illustrating a configuration of a liquid crystal display device in accordance with another embodiment of the present invention.

### DETAILED DESCRIPTION OF THE INVENTION

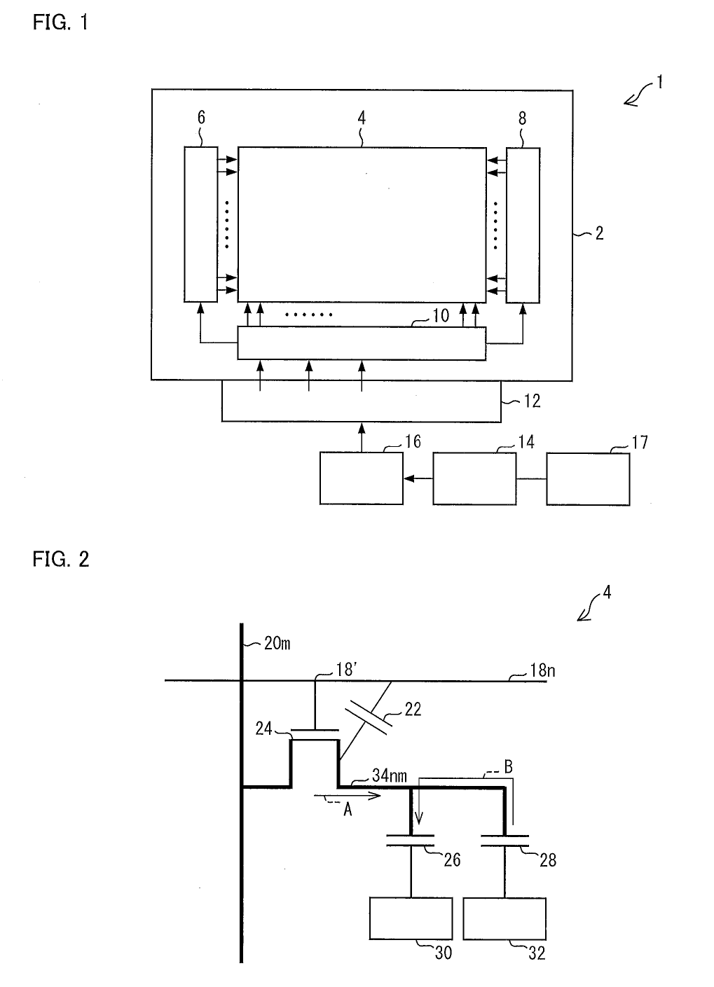

The following description will discuss Embodiment 1 in accordance with the present invention with reference to FIGS. 1 through 3.

### (Configuration of Liquid Crystal Display Device 1)

A configuration of a liquid crystal display device 1 will be first described below with reference to FIG. 1. FIG. 1 is a diagram illustrating a configuration of the liquid crystal display device 1. As illustrated in FIG. 1, the liquid crystal display device 1 includes a liquid crystal panel 2, a pixel circuit 4, a gate driver 6, a CS driver 8, a source driver 10, a flexible printed wiring board, that is, an FPC (Flexible Printed Circuit) 12, an illuminance sensor 14, a serial setting circuit 16, and an operation control section 17. The liquid crystal panel 2 is subjected to AC driving (inversion driving) for each frame period. Note that the detail of the liquid crystal panel 2 will be described later. The pixel circuit 4, the gate driver 6, and the CS driver 8 are incorporated into the liquid crystal panel 2. The source driver 10 is mounted on the liquid crystal panel 2 in a COG (Chip On Glass) manner.

The pixel circuit 4 includes a plurality of gate bus lines, a plurality of source bus lines, transistors, and retention capacitors, that is, CS capacitors. Note that the detailed configuration of the pixel circuit 4 will be described later with reference to another drawing. The gate driver 6 controls transistors to be turned ON/OFF, by applying voltages to the respective plurality of gate bus lines. The CS driver 8 applies voltages across the CS capacitors. The source driver 10 applies voltages to the respective plurality of source bus lines. Further, the source driver 10 supplies (i) control signals to respective of the gate driver 6 and the CS driver 8 and (ii) a retention voltage VCS to the CS driver 8. In accordance with the retention voltage VCS, the voltages to be applied by the CS driver 8 across the CS capacitors are adjusted.

The FPC 12 receives (i) a reset signal for resetting the liquid crystal display device 1, (ii) a timing signal for controlling timing at which a voltage is applied, and (iii) a data signal (all the signals (i) through (iii) are sent from a member (not illustrated), and then transmits the signals to the source driver 10. The FPC 12 further receives a three-wire serial signal sent from the serial setting circuit 16 and then transmits it to the source driver 10. The source driver 10 sets the retention voltage VCS in accordance with the three-wire serial signal. That is, by setting the three-wire serial signal, the serial setting circuit 16 can control voltages to be applied by the CS driver 8 across the CS capacitors.

The illuminance sensor 14, which is arranged outside the liquid crystal panel 2, detects an illuminance and sends a detected illuminance to the serial setting circuit 16. The serial setting circuit 16 controls the three-wire serial signal to be sent, in accordance with an illuminance received from the illuminance sensor 14. This allows the liquid crystal display device 1 to apply voltages across the CS capacitors in accordance with the illuminance detected by the illuminance sensor 14. The operation control section 17 controls the illuminance sensor 14 to be turned on or off in response to an external operation, for example, by a user.

Generally, when a liquid crystal display device is subjected to DS driving, a voltage to be applied across liquid crystal is determined by a voltage to be outputted from the CS driver 8 and a voltage to be outputted from the source driver 10. The voltage to be outputted from the source driver 10 is generally set so that a maximum voltage is to be applied across the liquid crystal. White brightness of the liquid crystal display surface is increased, as the voltage to be outputted from the CS driver 8 is increased. Note, however, that black brightness is also increased as the white brightness is increased. This causes a trade-off between the increase in white brightness and the increase in contrast. In view of the circumstances, the voltage to be outputted from the CS driver 8 is generally set so that such a trade-off is not caused.

### (Drive of Liquid Crystal Display Device 1)

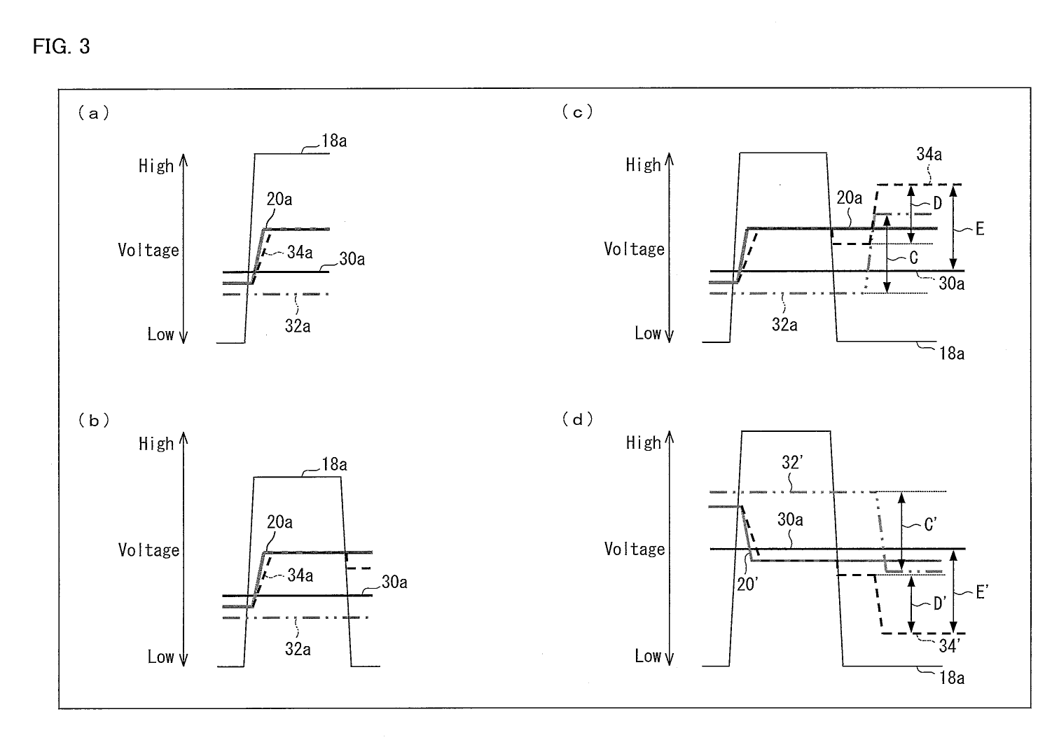

The following description will discuss how to drive the liquid crystal display device 1 with reference to FIGS. 2 and 3.

A main configuration of the pixel circuit 4 of the liquid crystal display device 1 will be first described below with reference to FIG. 2.

The pixel circuit 4 includes: a gate bus line 18n; a source bus line 20m; a parasitic capacitor (Cgd) 22; a transistor 24; a liquid crystal capacitor (Clc) 26; a CS capacitor (Ccs) 28; a COM electrode 30; and a retention capacitor electrode (CSn) 32, where n and m are respective arbitrary natural numbers. Capacitances Cgd, Clc, and Ccs generally meet a relation of Cgd<<Clc<Ccs.

The following description will explain how to drive the pixel circuit 4 with reference to FIG. 3. A voltage applied from the gate driver 6 is applied to a gate bus line 18n illustrated in FIG. 2. This causes (i) a gate 18′ on the gate bus line 18n to be opened and (ii) a transistor 24 to be turned ON. While the transistor 24 is being turned ON, a voltage supplied from a source bus line 20m will be applied, as illustrated by an arrow A, to a drain region 34 nm indicated with a bold line in FIG. 2. (a) of FIG. 3 illustrates, in this state, voltages at respective parts of the pixel circuit 4. The COM electrode 30 is subjected to DC driving.

In (a) of FIG. 3, a graph 18a shows a voltage at the gate bus line 18n, a graph 20a shows a voltage at the source bus line 20m illustrated with a bold line in FIG. 2, a graph 30a shows a voltage at the COM electrode 30, a graph 32a shows a voltage at the retention capacitor electrode 32, and a graph 34a shows a voltage at the drain region 34 nm illustrated with a bold line in FIG. 2.

As illustrated in (a) of FIG. 3, in response to a voltage applied to the gate bus line 18n, the voltage 18a at the gate bus line 18n is increased from a low gate voltage of −5 V to a high gate voltage of 10V. Since this causes the transistor 24 to be turned ON, the voltage applied from the source bus line 20m is applied to the drain region 34 nm. This causes the voltage 34a at the drain region 34 nm to be increased to 5V in accordance with the voltage 20a. In this state, the voltage 30a at the COM electrode 30 is 2V. And, the voltage 32a in the retention capacitor electrode 32 is a low voltage of 0V.

Subsequently, the applying of the voltage to the gate bus line 18n is stopped. This causes (i) the gate 18′ to be closed and (ii) the transistor 24 to be turned OFF. When the transistor 24 is thus turned OFF, the voltage 34a at the drain region 34 nm is affected by a feed-through voltage caused by the parasitic capacitor 22 (see FIG. 2). (b) of FIG. 3 illustrates voltages in this state. As illustrated in (b) of FIG. 3, the voltage 34a at the drain region 34 nm is decreased because of the feed-through voltage caused by the parasitic capacitor 22. The feed-through voltage caused by the parasitic capacitor 22 is expressed in the following Formula 1.

ΔV_{cgd}=(C_{gd}/ΣC)×(V_{gh}−V_{gl}) [Formula 1]

Subsequently, a voltage across the CS capacitor 28 is reversed. This causes a sharp rise in the voltage 34a at the drain region 34 nm, that is, a sharp rise in the voltage 34a via a capacitive coupling, as indicated by an arrow B of FIG. 2. The voltage 34a in the drain region 34 nm and the voltage 32a at the retention capacitor electrode 32 are thus increased, as illustrated in (c) of FIG. 3. The increase in the voltage 32a is affected by the inversion of the voltage across the CS capacitor 28. Specifically, the voltage 32a at the retention capacitor electrode 32 is increased from the low voltage of 0V to a high voltage of 4V. In (c) of FIG. 3, an arrow C indicates a variation, that is a CS amplitude of the voltage 32a across the retention capacitor electrode 32, and an arrow D indicates a variation of the voltage 34a at the drain region 34 nm. The variation of the voltage 34a is expressed by the following Formula 2.

ΔV_{drain}=(C_{cs}/ΣC)×(V_{csh}−V_{csl}) [Formula 2]

Then, a voltage indicated by an arrow E in (c) of FIG. 3, i.e., a difference between the voltage 30a at the COM electrode 30 and the voltage 34a at the drain region 34 nm, will be applied across the liquid crystal capacitor 26.

Subsequently, one frame period later, the voltage at the CS capacitor 28 is reversed. This causes a sharp drop in the voltage 34a at the drain region 34 nm via a capacitive coupling. (d) of FIG. 3 illustrates voltages in this state. When comparing (d) of FIG. 3 with (c) of FIG. 3, there is no change in each of the voltage 18a at the gate bus line 18n and the voltage 30a at the COM electrode 30. However, the voltage 20a at the source bus line 20m is reversed so as to become a voltage 20′ (that is, 0V). The voltage 32a at the retention capacitor electrode 32 is reversed so as to become a voltage 32′. A voltage 34′ at the drain region 34 nm, which is affected by a feed-through voltage caused by the parasitic capacitor 22, is further affected by a feed-through voltage caused by the retention capacitor electrode 32, so as to become a voltage 34′. In (d) of FIG. 3, an arrow C′ indicates a variation, that is a CS amplitude of the voltage 32′ across the retention capacitor electrode 32, and an arrow D′ indicates a variation of the voltage 34′ at the drain region 34 nm. The variation of the voltage 34′ is also expressed in the above-mentioned Formula 2. Then, a voltage indicated by an arrow E′, i.e., a difference between the voltage 30a at the COM electrode 30 and the voltage 34′ at the drain region 34 nm, will be applied across the liquid crystal capacitor 26.

As described above, a voltage to be applied across the liquid crystal capacitor 26 of the liquid crystal display device 1 is determined in accordance with a difference between (a) the voltage 30a at the COM electrode 30 and (b) the voltage 34a or (c) the voltage 34′ at the drain region 34 nm. As illustrated in (c) and (d) of FIG. 3, the voltage 34a and the voltage 34′ at the drain region 34 nm are affected by a CS amplitude, i.e., a voltage which is applied across the retention capacitor electrode 32 in response to the inversion of the voltage across the CS capacitor 28. As is clear from this, it is possible to control a voltage to be applied across the liquid crystal capacitor 26, by controlling a voltage to be applied across the CS capacitor 28 (retention capacitor). This makes it possible to adjust white brightness and black brightness on a screen of the liquid crystal panel 2 in the liquid crystal display device 1.

As is early described, the liquid crystal display device 1 can adjust the three-wire serial signal to be sent by the serial setting circuit 16 to the source driver 10, in accordance with an illuminance detected by the illuminance sensor 14. By adjusting the three-wire serial signal, the liquid crystal display device 1 can set a retention voltage VCS which is to be sent by the source driver 10 to the CS driver 8. With the use of this retention voltage VCS, the liquid crystal display device 1 can control (e.g., an amplitude of) a voltage to be applied by the CS driver 8 across the CS capacitor 28.

Accordingly, the liquid crystal display device 1 can set brightness in accordance with illuminance, by controlling a voltage, e.g., an amplitude of the voltage, to be applied by the CS driver 8 across the CS capacitor 28. Brightness is set to be high, for example, in a case where a surrounding illuminance is high in an environment, which is affected by outside light, such as the outdoors. This allows visibility to be improved even in an environment where outside light is strong. In contrast, in a case where a low illuminance is detected, display is carried out on a screen with a preset contrast. This generally causes a fine visibility of display. In such a case, the liquid crystal display device 1 will not apply a voltage wastefully, in order to adjust visibility. It is further possible to suppress an electric current consumption since a fine visibility can be attained without an increase in electric current to a backlight. Furthermore, the technology of the present invention is added to a liquid crystal display device which improves visibility by increasing an electric current to be applied to a backlight. This allows a further improvement in visibility of the liquid crystal display device, in outside light.

According to Embodiment 1, the CS driver 8 adjusts a voltage to be applied across the CS capacitor 28 for each frame. For example, in a case where (i) the illuminance sensor 14 detects a change in illuminance during a first frame and (ii) a voltage to be applied across the CS capacitor 28 is adjusted at a time by the CS driver 8 so as to become a final target voltage during a second frame by which the first frame is followed, there occurs a change in appearance of a screen in a moment of a single frame step from the first frame to the second frame. It appears to a viewer that glare on the screen occurs.

In view of the circumstances, the CS driver 8 can adjust a voltage to be applied across the CS capacitor 28 stepwisely over a plurality of frames after the illuminance sensor 14 detects a change in illuminance. This makes it possible to attain display while suppressing the glare on the screen.

Alternatively, the CS driver 8 can be configured such that, in a case where (i) a first illuminance, which has been detected by the illuminance sensor 14, changes to a second illuminance and then (ii) the second illuminance returns to the first illuminance within a predetermined time period, the CS driver 8 continues to apply a voltage across the CS capacitor 28 in accordance with the first illuminance. In other words, it is possible not to change a voltage to be applied across the CS capacitor 28 in a case where the second illuminance returns to the first illuminance within a short time period. This makes it possible to prevent a wasteful step of adjusting a voltage to be applied across the CS capacitor 28 in accordance with a temporal change in illuminance.

The liquid crystal display device 1 further includes an operation control section 17 for enabling or disabling the illuminance sensor 14. A user can disable the illuminance sensor 14, via the operation control section 17. In a case where the illuminance sensor 14 is disabled, the CS driver 8 applies a constant voltage across the CS capacitor 28, regardless of illuminance. That is, a user can set the CS driver 8 so that a constant voltage is applied across the CS capacitor 28, regardless of illuminance.

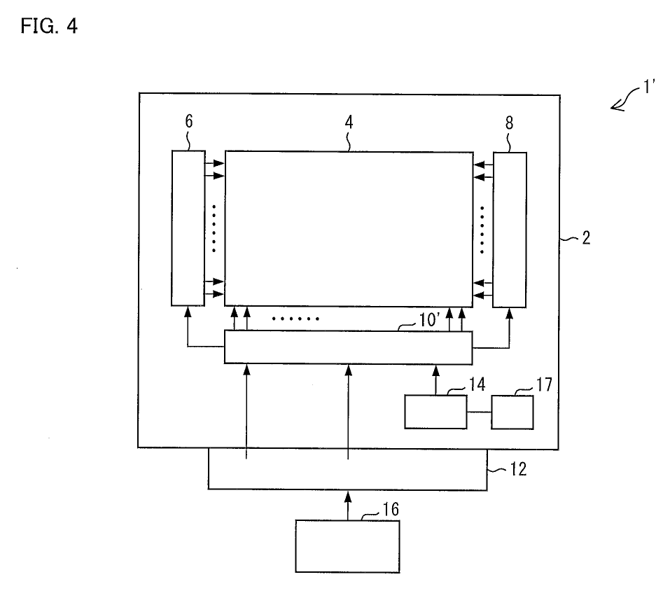

The following description will discuss another configuration of the liquid crystal display device 1 with reference to FIG. 4.

FIG. 4 is a diagram illustrating a configuration of a liquid crystal display device 1′. The liquid crystal display device 1′ differs from the liquid crystal display device 1 in that (i) the illuminance sensor 14 is incorporated into the liquid crystal panel 2 and (ii) the source driver 10′ has a LUT (look-up table). Note that description of the configurations of the liquid crystal display device 1′ which are equivalent to those of the liquid crystal display device 1 will be omitted.

In the liquid crystal display device 1′, the illuminance sensor 14 is incorporated into the liquid crystal panel 2. Therefore, the illuminance sensor 14 of the liquid crystal display device 1′ is arranged closer to a display surface, as compared with that of the liquid crystal display device 1. This allows the illuminance sensor 14 of the liquid crystal display device 1′ to detect an illuminance more precisely. It is thus possible to apply a more appropriate voltage across the CS capacitor 28. The source driver 10 includes a LUT in which a relation is specified between (i) respective illuminances detected by the illuminance sensor 14 and (ii) respective retention voltages VCS to be outputted across the CS driver 8. This allows the source driver 10 to supply a retention voltage VCS to the CS driver 8 in accordance with a detected illuminance. Note that values in the LUT can be set by a three-wire serial signal to be sent by the serial setting circuit 16 to the source driver 10 via an FPC 12. The liquid crystal display device 1′ can thus improve visibility by setting brightness in accordance with the illuminance. Alternatively, the technology of the present invention can be added to a liquid crystal display device which improves visibility by increasing an electric current to be applied to a backlight. This allows a further improvement in visibility of the liquid crystal display device, in outside light.

The liquid crystal display device 1′ of Embodiment 2 includes a look-up table, whereas the liquid crystal display device 1 of Embodiment 1 does not include a look-up table. Note, however, that the liquid crystal display device 1 of Embodiment 1 can includes a look-up table.

It is preferable that, in the liquid crystal display device in accordance with the present invention, the illuminance detecting means is incorporated into the liquid crystal panel.

According to the configuration, the illuminance detecting means is incorporated into the liquid crystal panel. This allows the illuminance detecting means to detect an illuminance of a liquid crystal surface more precisely. This brings bout a further effect that the liquid crystal display device can set an appropriate voltage to be applied across the retention capacitor.

It is preferable that the liquid crystal display device in accordance with the present invention further includes a look-up table in which a relation is specified between respective detected illuminances and respective voltages to be applied across the retention capacitor, the voltage applying means applying a voltage across the retention capacitor in accordance with the look-up table.

The above configuration brings about a further effect that the voltage applying means can adjust a voltage to be applied across the retention capacitor, in accordance with the look-up table in which a relation is specified between respective detected illuminances and respective voltages to be applied across the retention capacitor.

It is preferable that, in the liquid crystal display device of the present invention, the voltage applying means adjusts an amplitude of the voltage to be applied across the retention capacitor.

According to the configuration, the voltage applying means adjusts an amplitude of the voltage to be applied across the retention capacitor in accordance with the illuminance detected by the illuminance detecting means. This brings about a further effect that the liquid crystal display device can adjust brightness by adjusting an amplitude of the voltage to be applied, in order to improve the visibility.

It is preferable that, in the liquid crystal display device of the present invention, the voltage applying means adjusts, for each frame, the voltage to be applied across the retention capacitor.

According to the configuration, the voltage applying means adjusts, for each frame, a voltage to be applied across the retention capacitor. This brings about a further effect that the liquid crystal display device, which is generally subjected to AC driving (inversion driving) for each frame period can improve visibility.

It is preferable that, in the liquid crystal display device of the present invention, the voltage applying means adjusts the voltage to be applied across the retention capacitor stepwisely over a plurality of frames.

For example, in a case where (i) the illuminance detecting means detects a change in illuminance during a first frame, and (ii) a voltage to be applied is adjusted at a time so as to become a final target voltage during a second frame by which the first frame is followed, there occurs a change in appearance of a screen at a moment of a single frame step from the first frame to the second frame. It appears to a viewer that glare on the screen occurs.

This brings about a further effect that the liquid crystal display device can carry out display while suppressing the glare on the screen, by adjusting a voltage stepwisely over a plurality of frames after the illuminance detecting means detects a change in illuminance.

It is preferable that, in the liquid crystal display device of the present invention, in a case where (i) a first illuminance, which has been detected by the illuminance detecting means, changes to a second illuminance and then (ii) the second illuminance returns to the first illuminance within a predetermined time period, the voltage applying means continues to apply a voltage across the retention capacitor in accordance with the first illuminance.

According to the configuration, in a case where (i) a first illuminance, which has been detected by the illuminance detecting means, changes to a second illuminance and then (ii) the second illuminance returns to the first illuminance within a predetermined time period, the voltage applying means continues to apply a voltage across the retention capacitor in accordance with the first illuminance. A voltage is thus not changed in a case where the second illuminance returns to the first illuminance within a short time period. This brings about a further effect of preventing a wasteful step of adjusting a voltage to be applied across the retention capacitor in accordance with a temporal change in illuminance.

It is preferable that the liquid crystal display device of the present invention further includes operation control means for enabling or disabling the illuminance detecting means in response to an external operation, the voltage applying means applying a constant voltage across the retention capacitor, in a case where the illuminance detecting means is disabled.

According to the configuration, the liquid crystal display device further includes operation control means for enabling or disabling the illuminance detecting means in response to an external operation. This brings about a further effect that a user can cause the voltage applying means to apply a constant voltage across the retention capacitor, regardless of illuminance, by disabling the illuminance detecting means.

The present invention encompasses a mobile device including the liquid crystal display device.

The present invention is not limited to the Embodiments, and various modifications are therefore possible within a scope defined by Claims. The technical scope of the present invention encompasses embodiments obtained by appropriately combining the technical means disclosed in different embodiments.

In the Detailed Description of the Invention, specific embodiments or examples are simply described in order to clarify the technical contents of the present invention. The present invention is not to be construed narrowly as being limited to such specific embodiments or examples. The present invention can be embodied on the basis of the spirit of the present invention and variation within the scope of the Claims.

A liquid crystal display device, a mobile device, and a method for driving the liquid crystal display device in accordance with the present invention are applicable widely to general liquid crystal display devices for use in electronic apparatuses or other apparatuses.

1. A liquid crystal display device comprising:
a pixel circuit in which a retention capacitor is provided;
illuminance detecting means for detecting an illuminance on a liquid crystal display surface of a liquid crystal panel of the liquid crystal display device; and
voltage applying means for applying a voltage across the retention capacitor in accordance with the illuminance detected by the illuminance detecting means.

2. The liquid crystal display device as set forth in claim 1, wherein:
the illuminance detecting means is incorporated into the liquid crystal panel.

3. A liquid crystal display device as set forth in claim 1, further comprising:
a look-up table in which a relation is specified between respective detected illuminances and respective voltages to be applied across the retention capacitor,
the voltage applying means applying a voltage across the retention capacitor in accordance with the look-up table.

4. The liquid crystal display device as set forth in claim 1, wherein:
the voltage applying means adjusts an amplitude of the voltage to be applied across the retention capacitor.

5. The liquid crystal display device as set forth in claim 1, wherein:
the voltage applying means adjusts, for each frame, the voltage to be applied across the retention capacitor.

6. The liquid crystal display device as set forth in claim 1, wherein:
the voltage applying means adjusts the voltage to be applied across the retention capacitor stepwisely over a plurality of frames.

7. The liquid crystal display device as set forth in claim 1, wherein:
in a case where (i) a first illuminance, which has been detected by the illuminance detecting means, changes to a second illuminance and then (ii) the second illuminance returns to the first illuminance within a predetermined time period, the voltage applying means continues to apply a voltage across the retention capacitor in accordance with the first illuminance.

8. A liquid crystal display device as set forth in claim 1, further comprising:
operation control means for enabling or disabling the illuminance detecting means in response to an external operation,
the voltage applying means applying a constant voltage across the retention capacitor, in a case where the illuminance detecting means is disabled.

9. A mobile device comprising a liquid crystal display device recited in claim 1.

10. A method for driving a liquid crystal display device,
said device comprising a pixel circuit in which a retention capacitor is provided,
said method comprising the steps of:
(i) detecting an illuminance on a liquid crystal display surface of a liquid crystal panel of the liquid crystal display device; and
(ii) applying a voltage across the retention capacitor in accordance with the illuminance detected in the step (i).
